(19) United States
(12) Patent Application Publication
(10) Pub. No.: US 2005/0279566 A1
(43) Pub. Date: Dec. 22, 2005

(54) Loudspeaker

(76) Inventors: Anthony Hooley, Cambridge (GB); Simon Andrew Longbottom, Cambridge (GB)

Correspondence Address: NIXON & VANDERHYE, PC, 901 NORTH GLEBE ROAD, 11TH FLOOR, ARLINGTON, VA, 22203, US

(21) Appl. No.: 10/528,106

(22) PCT Filed: Sep. 17, 2003
(86) PCT No.: PCT/GB03/04005

§ 371 Date: May 6, 2005

(30) Foreign Application Priority Data
Sep. 17, 2002 (GB) 0221503.6

(51) Int. Cl. H04R 7/00; G10K 13/00

(52) U.S. Cl. 181/163

(57) ABSTRACT

A loudspeaker is described with two closely spaced diaphragms simultaneously driven by the two ends of an actuator. By balancing the impedance load of both diaphragms on the actuator both diaphragms radiate in phase and hence improve sound reproduction and efficiency of operation.

### FIELD OF THE INVENTION

The present invention relates to loudspeakers, particularly loudspeakers suitable for generating audible sound of HiFi quality. More specifically, it relates to loudspeakers having a sound generating element or diaphragm with an electro-mechanical transducer mounted thereon.

### BACKGROUND OF THE INVENTION

The reproduction of audio recordings has been until very recently dominated by electromagnetic voice-coil driven cone-shaped diaphragms mounted in boxes or similar enclosures. Alternative technologies, using for instance alternative drivers or planar diaphragms have been introduced but are not yet widespread either due to high costs, as, for example electrostatic loudspeakers, or due to the poor quality of the sound generated, as for example piezoelectrically driven wideband loudspeakers, which have been almost exclusively used for low-sound-quality devices, such as greeting cards, buzzers, telephone speakers and the like.

Planar and piezoelectric loudspeakers are described in many prior art documents including U.S. Pat. Nos. 4,654,554; 4,969,197; 5,514,927; 5,780,958; 5,736,808; 6,078,126; 6,091,181; 6,198,206 and the published international patent application WO-9203024.

Known speakers include pistonic speakers and bending wave loudspeakers (“BWL”).

Conventional speakers operate in pistonic mode, in which the driver, usually an electo-magnetic voice-coil, pushes a diaphragm back and forth like a piston. The diaphragm is designed to be relatively stiff, such that it bends little on operation. For this reason, the diaphragm is usually designed as a cone to impart some additional structural stiffness. However, pistonic speakers with planar diaphragms are also known. In operation, sound is radiated equally from the front and rear of the diaphragm, the front- and rear- radiated sound being necessarily in anti-phase. To avoid cancellation of the desired sound by the rear-radiated sound, such speakers are generally housed in sturdy boxes or cabinets, such that the rear-radiated sound is trapped. It is therefore difficult to produce such speakers in a compact, lightweight form.

Known bending-wave loudspeakers (“BWL”), also referred to as flexural wave or distributed mode loudspeakers, have a thin area-extensive flexible panel that is driven by an actuator close to the centre (but not usually at the centre) in a direction orthogonal to the plane of the panel so as to induce bending out of the plane of the panel. Bending waves travel across the panel surface and are partially reflected by the impedance discontinuity at the panel edges. Multiple reflections occur and dense wave patterns form on the surface. If the panel is immersed in a fluid, such as air, then sound waves are generated in the fluid and the device may be used as a loudspeaker.

Conventional BWL use magnetic or piezoelectric actuators to produce the bending waves. A magnetic moving-coil actuator has very asymmetric properties—its moving-coil has a very low mass and when driven by an electric current experiences a driving force relative to the very much heavier magnet. When actuated the coil usually moves with high velocity and the magnet with very low velocity. This asymmetry is usually emphasised by clamping the magnet assembly to the nominally fixed frame of the machine containing the actuator.

In a conventional magnetically driven BWL the magnet of the moving-coil actuator is often fixed to the nominally static frame of the loudspeaker, while the moving coil is attached to the flexible panel to be driven. Reaction forces are thus between the panel and the loudspeaker frame. In an alternative arrangement, the moving-coil is attached to the flexible panel and the magnet assembly is allowed to hang free coupled only by the suspension of the actuator. Upon driving the actuator, the high inertia of the magnet assembly is used to provide reaction force to the coil and panel. In this latter configuration, the loudspeaker need have no frame as such, though some means of support of the whole assembly is generally provided to allow floor or wall mounting and to improve the durability of the device.

In piezoelectrically driven BWL the actuators are generally symmetrical and the inertial mass of the actuators available is generally inadequate to provide sufficient reaction force and a mounting frame becomes required if the panel is to be adequately driven. Such a mounting frame generally contributes nothing to the sound output, and simply adds weight and cost to the device. If it is to not reduce the efficiency of driving of the panel, the frame needs to be adequately stiff and lossless—these properties are incompatible with very low weight, low mechanical impedance and low cost.

In conventional BWL at medium to high frequencies, the radiation from each face of the panel adds constructively as approximately random-phase radiation, the two radiating surfaces producing a total sound power roughly square-root-of-two as big as the contribution from one side alone. However, at low frequencies, where the dimensions of the panel become comparable to the wavelength of the bending waves within the panel, the panel starts to act effectively as a piston-radiator and at these low frequencies the phase of the radiated sound produced by one side of the panel is necessarily opposite to that produced by the other side of the panel. A consequence is that such low frequency radiation as occurs tends to mutually cancel itself in the far field leading to poor low frequency performance overall and, therefore, require a housing or cabinet.

Therefore it would be desirable to provide a compact, lightweight loudspeaker with improved sound reproduction and improved efficiency. It would also be desirable to improve piezoelectrically driven loudspeakers, of both pistonic and BWL types.

### SUMMARY OF THE INVENTION

According to a first aspect, the invention provides a balanced form of loudspeaker. A low mass and low impedance electroactive actuator, preferably a piezoelectric actuator of the bending type and more preferably of the coiled bending type, is used as the actuator to drive two opposing diaphragms in order to produce sound. A balanced configuration is proposed, eliminating the requirement for a relatively massive mounting frame or housing.

The balanced configuration is preferably achieved by a pair of area extensive approximately parallel thin panels (a type of diaphragm) spaced apart by a small distance, sufficient to allow the actuator (or actuators) to be placed between their co-facing surfaces. To be balanced, the parallel panels are preferably closely impedance matched within the surrounding fluid, such that the energy of the actuator is transferred to both panels in essentially equal amounts. A preferred configuration that achieves impedance matching is to use two identical or essentially identical panels.

Any diaphragms may be used in place of the panels.

One end of the or each actuator is fixed to the first panel and the other end of the or each actuator is fixed to the second opposing panel, the actual relative positions being determined by the actuator geometry, but in general the two ends are fixed at points on the two panels which are roughly opposite each other. The nature of the actuator is chosen such that its length in a direction orthogonal to the plane of each of the panels changes when driven electrically, and in general the actuator will both lengthen and shorten under electrical drive. A suitable actuator is a coiled-coil piezoelectric actuator of the Helimorph™ type, as described in WO 01/47041 and WO 01/47318, the disclosures of which are hereby incorporated by reference.

When the actuator lengthens, the panels are pushed apart and when the actuator shortens, the panels are pulled together. The sound radiated from the outward facing surfaces of the two panels is therefore in phase. In this balanced case, the rear-radiated anti-phase sound is generated at the inward-facing sufaces of the panels. Such anti-phase sound will be somewhat attenuated in the narrow gap between the panels, particularly if the panels are extensive in relation to their separation, such that reduced sound cancellation will occur in the listening area.

Such a balanced speaker may use one or several actuators. In a pistonic speaker, one or several actuators are positioned such that each panel moves back and forth with minimal bending. A smaller, stiffer panel may be driven pistonically by a single actuator positioned approximately centrally, wheras a larger or less stiff panel may require two or more actuators for pistonic operation.

In a BWL device, the position chosen for placement of the actuator(s) relative to the edges of the panels can follow the well-known and generally accepted positioning rules for BWL, e.g. close to the centre, at 3/7 of the length of the panel and 4/9 of its width.

The balanced speaker of the invention may operate in pistonic mode, in BWL mode or in a mixture of the two, depending on the number and position of the actuators and the stiffness and size of the panels.

In a variant of the above arrangement, the spacing between the panels may be reduced to less than the clearance height of the actuator. The “height” is defined as the dimension of the actuator in the direction in which it actuates. For example, the actuator can be partially housed within the thickness of one or both of the panels by removing the panel core material adjacent to the actuator. The actuator may then be attached to the inner of one or both panels rather than to the panel surface. The two panels can then be positioned such that the gap between them becomes very narrow, particularly when combined with an actuator assembly of reduced height (e.g. a single turn flat Helimorph™). Even closer spacing of the two panels can be achieved by forming the outer face of the diaphragms as shallow protrusions, e.g. dome shaped, at the location of the actuator.

The panels are preferably planar with a flat or curved shape and are preferably made of a low-weight material with a high stiffness. Such materials are known and often include a composite structure. Known composite materials include for example a layer of honeycomb structure made from resin paper or light metals, enclosed in two sheets of reinforced resin. Polymer variants of this structure are also available, such as foamed-core boards. Stiffer panels drive more easily in pistonic mode, while less stiff panels are more suitable for bending wave operation. For BWL, the panels are preferably essentially flat whereas for pistonic operation, the panel may be designed such that its shape contributes to panel stiffness, for instance in designs incorporating curved, domed or conical diaphragms.

The loudspeaker of the invention requires no massive frame or housing, but preferably includes an attachment or support means. The attachment point is preferably selected to be at a point which is stationary, or nearly so, during operation. Alternatively, the diaphragm may be compliantly mounted to the support means such that the diaphragm remains essentially free to vibrate.

A stationary point is found on the actuator half way between its ends. An attachment can be made at this point, for instance by gluing or mechanical fixing, to a suitable support member such as a pin or cable. Several supports can be provided if there are several actuators.

Alternatively, a support member may be flexibly attached to both panels so that the panels are supported by the member but may move freely in a direction normal to their sufaces. The member may then be used to support the whole balanced loudspeaker. The support member may be simply a cable (or cables) from which the panels are suspended, or may comprise a rigid element, for example a pin, coupled to the panels with a compliant element, for example a foam plastic pad.

In a BWL device, attachment points are preferably at suitable points of minimal bending displacement (“nodal points”) where the amplitude of bending waves is lowest in normal operation of the BWL. In addition, fixings and spacers may be attached at these points that fix one panel relative to the other (locally) and determine their precise mutual separation. Such fixings may be either rigid (e.g. bolts with rigid spacer pieces between the panels) or compliant (e.g. foamed polymer pads providing nominal spacing and which may be bonded to the panel surfaces), or alternatively may comprise both rigid and compliant elements, where compliant pads are used as standoffs for rigid fixing pins holding the two panels apart, but acoustically decoupled from the panels by the compliant pads. Suitable fixing points depend on the properties of the panels and include, in the case of rectangular panels, positions close to their edges but not at the edges. Suitable positions are within a distance from the edge of 1/9 of the width or length, respectively. It may be beneficial to reinforce these attachment points.

Therefore, in a preferred variant the two panels are fixed to each other by only a limited number of point connections, which may be solely through the actuator(s), leaving a continuous, connected fluid-filled space or volume between the panels. The edges of the panels are left to move freely, or, if a sealing connection to the surrounding is required, connected with highly compliant material such as elastomer.

Another preferred design consideration aims at reducing the distance between the two panels. In general, this distance will be determined by the size of the actuator placed between them. However, given the current size of such actuators a spacing of less that 10 mm, or even less than 5 mm can be regarded as feasible. A lower limit of the distance is defined by twice the peak amplitude of the panels, independent of whether it oscillates in a bending or in a pistonic mode, to avoid a contact between the two panels in operation. These considerations lead to a practical distance between the inner faces of the panels of around 1 to 4 mm for most loudspeaker applications.

Though potentially various designs of piezoelectric transducer may be suitable for the purpose of the present invention, the benders described, for example, in the international patent application WO-0147318 are particularly well suited for this application which demands a large displacement of the actuator in order to generate high sound pressure levels. As mentioned above, the Helimorph™, a twice-coiled piezoelectric bender, is probably the best actuator for the proposed application. However, in principle any low mass and high displacement actuator may be used to drive the loudspeaker panels.

The load impedance seen by the driving actuator(s) will be approximately one half that produced had just one of the panels been driven in the conventional way relative to a stiff or massive frame or inertial reaction mass. This lowering of load impedance facilitates the task of matching a given panel material to a low-impedance actuator such as a Helimorph™.

Such a balanced loudspeaker has several advantages over current conventional designs in that there is no requirement for a cabinet or, in the case of a BWL device, a heavy inertial reaction load for the actuator. The loudspeakers in accordance with the above aspects of the invention can be made very thin and very lightweight. They have an improved sound output, particularly at low frequencies, and a reduced load impedance on the actuator, leading to greater efficiency.

These and other features of the inventions will be apparent from the following detailed description of non-limitative examples making reference to the following drawings.

### BRIEF DESCRIPTION OF THE DRAWINGS

In the drawings:

FIG. 1 is a cross-sectional view of a known panel loudspeaker;

FIG. 2A is a cross-sectional view of an embodiment of the present invention;

FIG. 2B is a perspective view of the embodiment of FIG. 2A;

FIG. 3 is a cross-sectional view of another embodiment of the present invention;

FIG. 4 is a cross-sectional view of a further embodiment of the present invention;

FIG. 5A is a cross-sectional view of a pistonic balanced speaker of the invention;

FIG. 5B is a perspective view of the embodiment of FIG. 5A.

FIG. 5C is a perspective view of a further embodiment of the pistonic speaker of the present invention.

FIGS. 6A and 6B are cross-sectional views of two further embodiments of the present invention;

FIG. 7 is a cross-sectional view of a mounting means for the speaker of the present invention;

FIG. 8 is a cross-sectional view of a further mounting means;

FIG. 9 is a cross-sectional view of a further mounting means.

### DETAILED DESCRIPTION

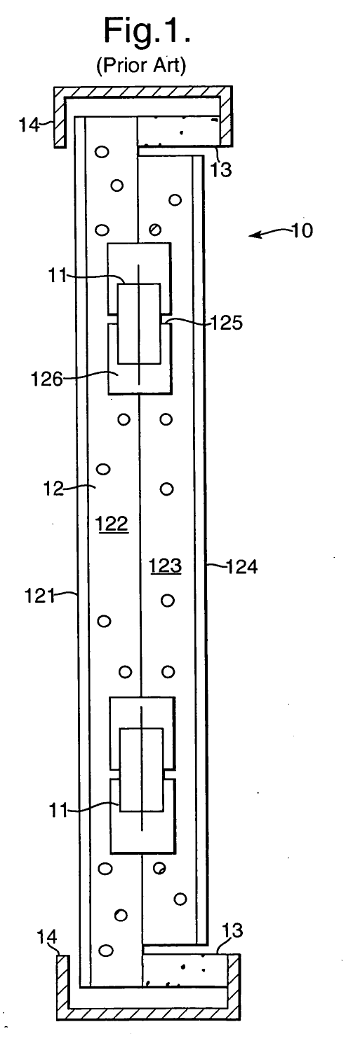

A number of different panel speakers are known. In FIG. 1, there is shown an example of a piezoelectrically driven loudspeaker 10 with drivers 11 integrated into a diaphragm 12 that is composed of several layers 121 to 124. The drivers 11 are mounted onto small projection members 125 within a recessed space 126 within the two resin foam layers 122, 123. By assembling the two layers 122, 123 a single diaphragm 12 with integrated drivers 11 is produced. When activating the drivers 11, the diaphragm 12 emits sound from both main surfaces 121, 124. Through elastic supporting members 13, the diaphragm 12 is mounted onto an outer frame structure 14.

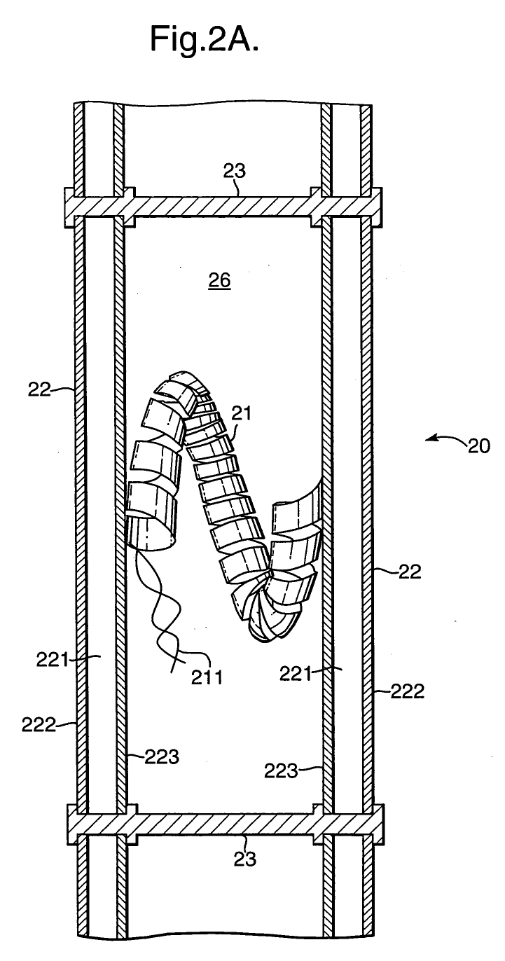

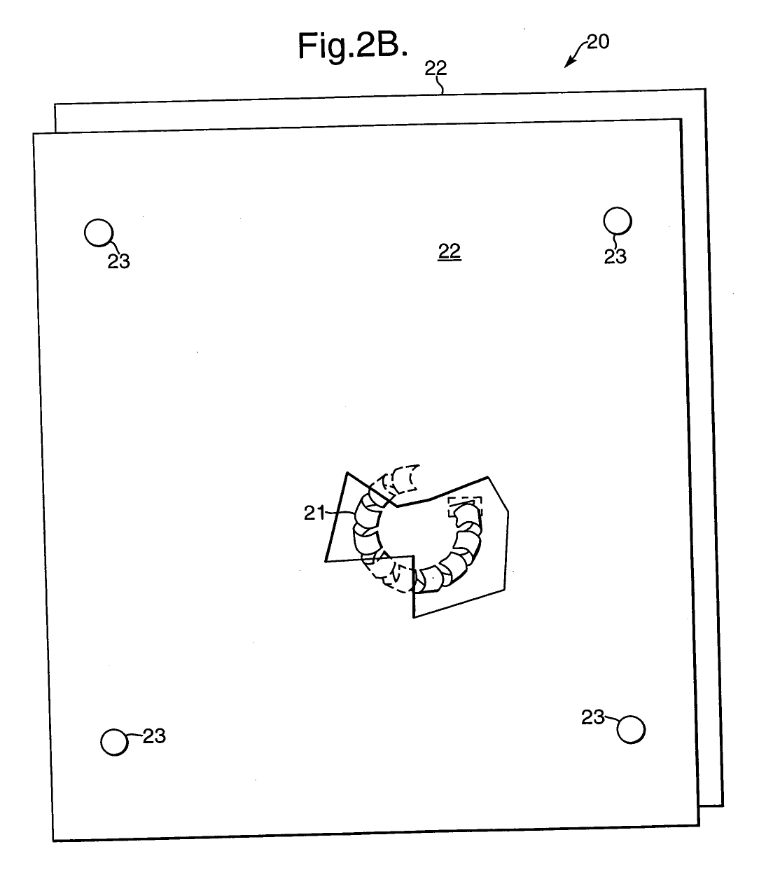

In an example in accordance with the present invention as shown in FIG. 2, the bending wave loudspeaker 20 includes two flat panel diaphragms 22. For stability and maximum stiffness at minimum weight, each diaphragm 22 has a honeycomb core layer 221 enclosed between two cover layers 222, 223 of carbon-fibre reinforced resin. Both diaphragms are essentially identical rectangles of 25 cm by 35 cm. The two diaphragms 22 are connected and spaced apart approximately 4 mm by rivets 23 leaving an inner volume 26 filled with air. A piezoelectric driver 21 is mounted between the opposing inner faces 223 of the two diaphragms 22 such that one end of the actuator 21 is in a force-transmitting connection with one diaphragm whilst the other end of the driver is connected to the opposite diaphragm, again in a force-transmitting connection. The driver 21 is a Helimorph™ with the minor helix turned by approximately one full turn. Leads 211 are supplied to apply a signal to the actuator 21 during operation. The actuator is preferably mounted on studs (not shown) to facilitate manufacturing of the device.

The perspective view of FIG. 2B has a cut-away section showing the driver 21 in a slightly off-centred position at 3/7 of the length of the panel and 4/9 of its width. The rivets 23 are placed at a distance from the edge of approximately 1/9 of the fall length or width, respectively, of the panel diaphragms 22, leaving the edges free to follow the bending motion induced through the actuator 21. However, the rivets may be placed at other positions that do not interfere with the bending wave motion.

The loudspeaker 20 can be suspended from wires or stands (not shown) attached for example to the rivets 23 or the edges of the loudspeaker.

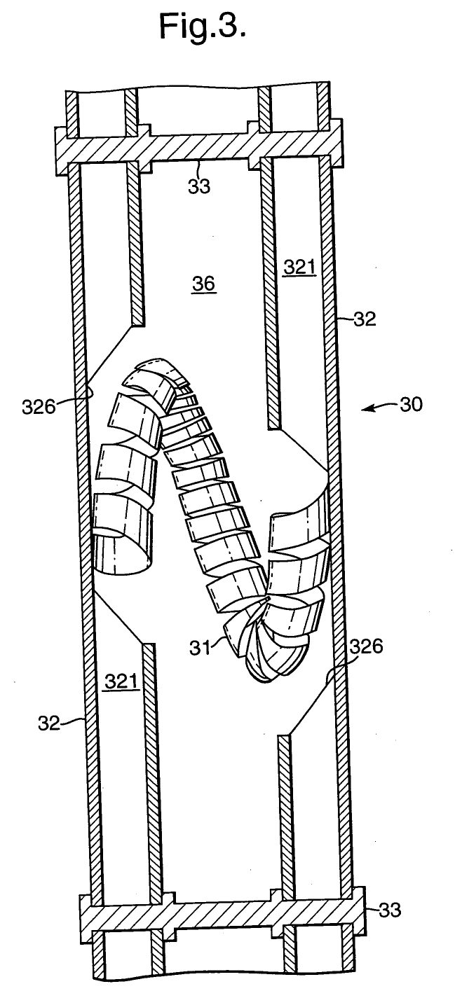

In another example of the invention, shown in FIG. 3, the two diaphragms 32 of the loudspeaker 30 are brought closer together compared to the previous example. As the spacing between the two panels is reduced to less than the effective height of the actuator 31, its ends are placed within recess sections 326 formed by machining away part of the core layer 321 of both panels 32. Optionally, these recessed sections of diaphragm are reinforced. As above, the two diaphragms 32 are connected and spaced apart by rivets 33 leaving an enclosed volume 36 filled with air. The driver 31 is a Helimorph™ actuator.

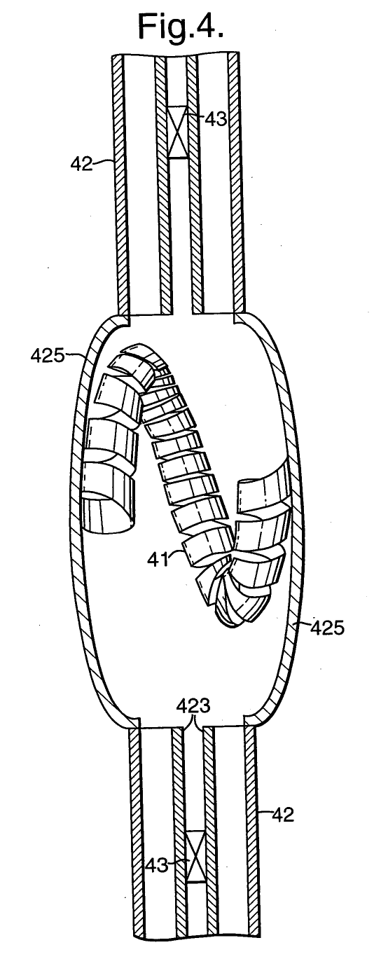

In the example as illustrated by FIG. 4, the actuator 41 is housed within two concave inserts 425 in each of the diaphragms 42. At their rim, the inserts 425 are firmly connected to the respective diaphragms 42. In this example small, compliant foamed pads 43 are glued to the inner faces 423 to maintain a default spacing between the two diaphragms 42. The driver is a Helimorph™, however the configuration enables the use of other bigger drivers, such as stacks of recurved piezoelectric benders and so-called moonies.

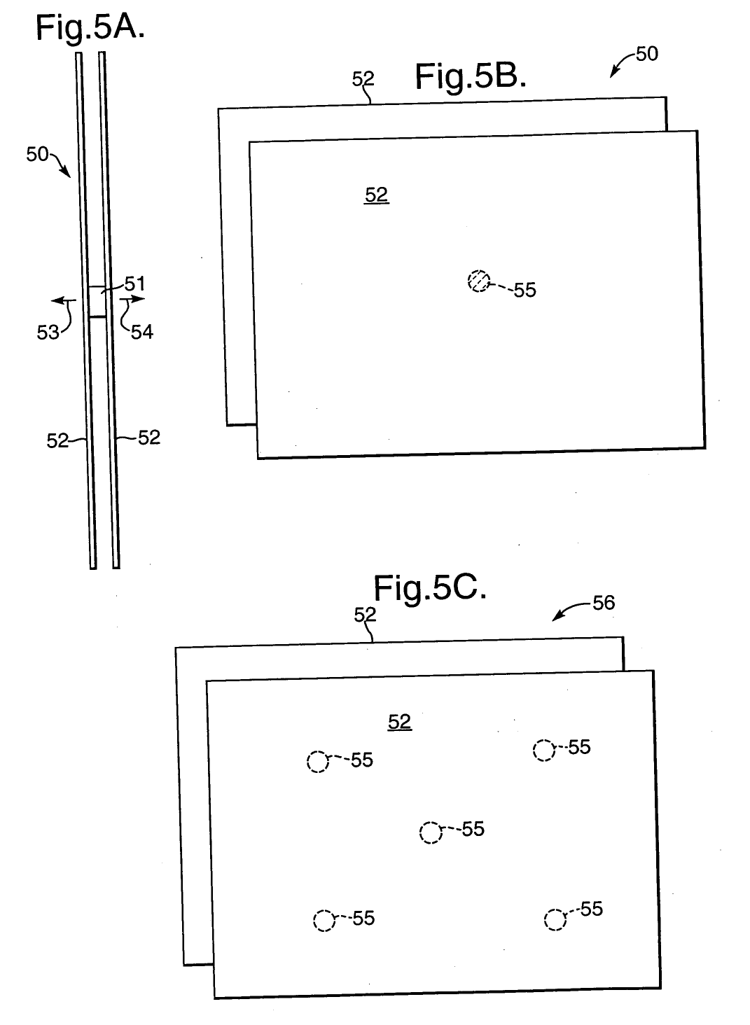

FIG. 5A shows a schematic cross-section through a balanced pistonic loudspeaker 50 comprising a single actuator 51 attached to two diaphragms 52. In operation, the actuator 51 lengthens and shortens. When the actuator lengthens, the diaphragms move in the direction of the arrows 53, 54 and conversely, when the actuator shortens, the diaphragms move in the reverse directions.

In FIG. 5B is shown in perspective view the loudspeaker 50 comprising the two diaphragms 52 and actuator 51 (not visible). The position 55 of the actuator is shown by dashed lines at approximately the centre of the face of the front diaphragm 52. FIG. 5C shows a perspective view of an example of a speaker 56 with several actuators (not visible), whose positions are marked by the dashed circles 55 on the front one of the two diaphragms 52. The actuators are all driven with the same signal. The use of several actuators allows less stiff diaphragms to be used, even for pistonic speakers, as there are several driving points.

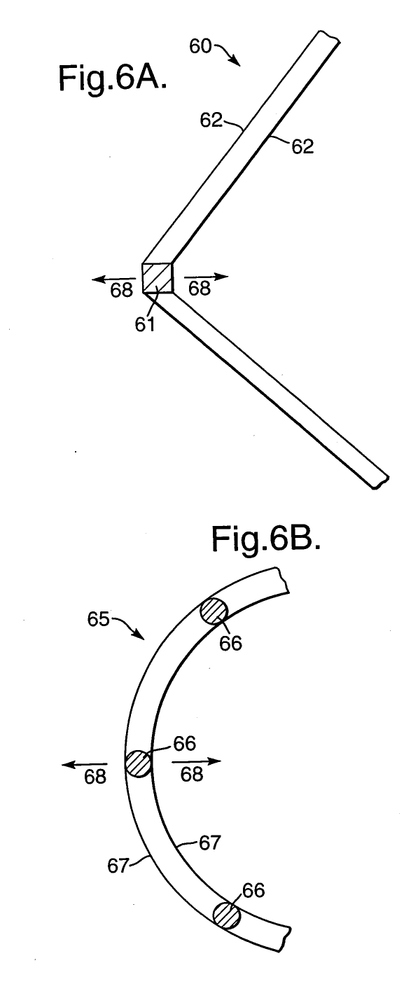

FIG. 6 shows examples of the balanced speakers of the invention, in which the diaphragms are not flat panels. FIG. 6A is a cross-section through a pistonic speaker 60 comprising two nested conical diaphragms 62 driven by an actuator 61 at the apex of the cone, while FIG. 6B is a cross-section through a speaker 65 comprising two nested domed diaphragms 67 driven by several actuators 66. Such shaped diaphragms are common in conventional speakers, since the shape imparts some measure of structural stiffness. Other non-planar shapes can also be used. In the balanced speaker case, the two diaphragms are essentially similar in shape and are ‘nested’ such that the gap between them is essentially constant. The arrows 68 in FIGS. 6A and 6B indicate the direction of movement of the diaphragms 62, 67 when the actuators 61, 66 lengthen.

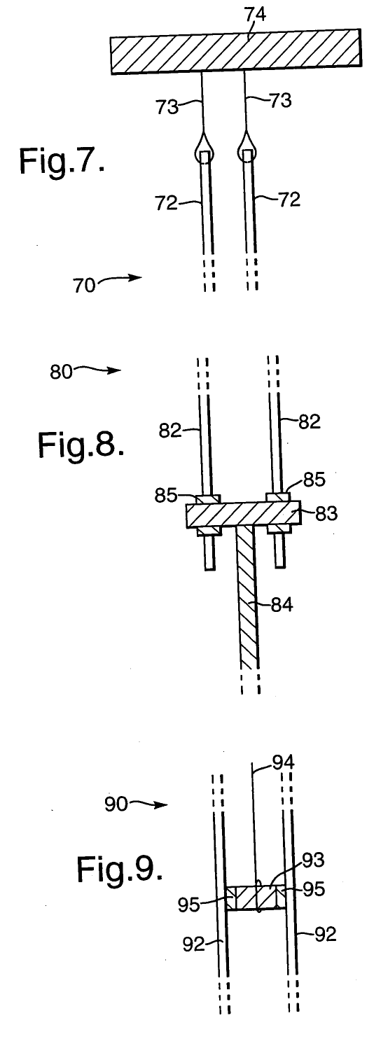

Examples of mounting means for the balanced loudspeakers of the invention are shown in FIGS. 7, 8 and 9.

FIG. 7A shows a simple mounting means in which the two diaphragms 72 of a balanced speaker 70 are suspended by cables 73 from a rigid mount 74. FIG. 7A is a cross section showing the top part of the diaphragms. The cables, or connectors attached to the cables, pass through holes made in the diaphragms for this purpose. The holes are preferably reinforced in some way. The diaphragms 72 remain free to vibrate. The mount 74 may be fixed for example to a wall, a ceiling or a floor mounted post (not shown).

FIG. 8 shows a cross-section through a mounting means comprising a rigid pin 83 resting in compliant gaskets 85 inserted near the bottom edge of the diaphragms 82 in a balanced speaker 80 (upper portion not shown). The gasket material is chosen such that the diaphragms 82 are relatively free to vibrate. The pin 83 is shown attached to a vertical post 84, which could be floor or wall mounted. Similar mounting means could be provided at the side or top edges, and the pin could be suspended from above instead of mounted from below.

A suspended mounting is shown in cross-section in FIG. 9 where a rigid pin 93 is connected to compliant pads 95 which are in turn connected to the two diaphragms 92 of a balanced speaker 90. In the example shown, the mounting pin 93 is suspended by a cable 94.

1. A loudspeaker comprising
a first diaphragm and second diaphragm, the first and second diaphragms being flat panels arranged in parallel with a continuous fluid-filled gap between them and having essentially equal impedance, and
at least one piezoelectric actuator coupled by a first end to said first diaphragm and a second end to said second diaphragm to simultaneously excite vibrations in said first and second diaphragm.

2. (canceled)

3. The loudspeaker of claim 1, wherein the first and second diaphragms are essentially identical.

4.-5. (canceled)

6. The loudspeaker of claim 1, wherein the diaphragms are separated by less than one tenth of their smallest lateral dimension.

7. The loudspeaker of claim 41, wherein the diaphragms are separated by a average distance of less than ten millimetres.

8. (canceled)

9. (canceled)

10. The loudspeaker of claim 91, wherein the actuator is a coiled-coil piezoelectric bender.

11. The loudspeaker of claim 1, wherein the height of the actuator exceeds a minimal spacing between the first and the second diaphragm.

12. The loudspeaker of claim 1, mounted by suspending the diaphragms on cables.

13. The loudspeaker of any one of claim 1, mounted by a support element extending between the diaphragms.

14.-18. (canceled)

19. The loudspeaker of claim 1, comprising a plurality of said piezoelectric actuators.

20. The loudspeaker of claim 1, wherein the acoustic output of the first and second diaphragms is balanced.

21. The loudspeaker of claim 1, wherein the at least one piezoelectric actuator is arranged to excite vibrations in said first and second diaphragm in a pistonic mode.

22. The loudspeaker of claim 1, wherein the at least one piezoelectric actuator is arranged to excite vibrations in said first and second diaphragm in a bending wave mode.

23. The loudspeaker of claim 1, wherein the at least one piezoelectric actuator is arranged to excite vibrations in said first and second diaphragm in a mixture of a pistonic mode and a bending wave mode.
